(19) United States
(12) Patent Application Publication
(10) Pub. No.: US 2003/0163413 A1
(43) Pub. Date: Aug. 28, 2003

(54) Method of conducting anonymous transactions over the internet

(76) Inventor: Frank T. Wiczkowski, Wyomissing, PA (US)

Correspondence Address: Larry W. Miller, Esquire, Miller Law Group, PLLC, 25 Stevens Avenue, West Lawn, PA, 19609, US

(21) Appl. No.: 10/085,351

(22) Filed: Feb. 28, 2002

(51) Int. Cl. G06F 17/60

(52) U.S. Cl. 705/38

(57) ABSTRACT

A method of conducting anonymous transactions over the Internet protects consumers from identity fraud. The process involves the formation of a Secure Anonymous Transaction Engine to enable any consumer operating over an open network, such as the Internet to browse, collect information, research, shop, and purchase anonymously. The Secure Anonymous Transaction Engine components provide a highly secure connection between the consumer and the provider of goods or services over the Internet by emulating an in store anonymous cash transaction although conducted over the Internet. The Secure Anonymous Transaction Engine is accessible to all merchants conducting business over the Internet and does not require subscription to any special service.

### BACKGROUND OF THE INVENTION

This invention relates generally to the field of conducting secure, anonymous transactions, occurring through an open network such as the Internet, and more particularly, to conducting anonymous transactions such as electronic payment processing, order fulfillment, secure browsing, secure shopping, and secure purchasing from merchants and or storefronts located on the Internet.

The Internet is an open network. As a consequence of the openness of the Internet, the risks of fraud and or the illegal use of personal information are growing at an increasing rate. Each time a consumer provides personal information in electronic form over the Internet, the risk of identity fraud increases. As the Internet continues to grow and expand, the consumer is drawn to the Internet to purchase goods and services from merchants that could be located anywhere in the world. In this expansive use of the Internet lies one of the major impediments to ubiquitous use of the Internet to purchase goods and services, the consumer is informed enough to know that their risks of misuse of their personal information and of fraud must be considered each time the consumer provides any personal information over an open network such as the Internet.

Purchasing goods and services on the Internet is also impeded by the proliferation of viruses, worms, covert monitoring programs and hackers all over the world. Over the last several years of the 1990's and into 2002, the Internet has seen an explosion in the number of attacks and breaches of systems containing sensitive, personal and valuable information. The attacks are not limited to small, unknown merchants that do not have the current technology or expertise to implement security measures. The hackers are indiscriminant in their choice of targets.

Certification programs for merchant back office systems are beginning to surface to address the lack of a secure merchant standard. Visa's Electronic Compliance Program and Master Card's Secure Payment Application are both systems designed to protect the card issuer and the merchant from charge backs and unauthorized transactions. However, these systems do not address the increasing risk to the consumer for identity fraud and the misuse of personal information. Each time a consumer provides personal information to another party, the risk of misuse of their personal information increases. The rate of the increased risk can be nonlinear. The risk can increase exponentially, if the merchant disseminates personal consumer information to other parties.

The credit card issuing companies and the merchants they serve are taking steps to address the risk of fraud and lost revenue that results in charge backs and lost profits. These systems include vendor certification of merchant back office systems and processes. However these systems do nothing to limit the risk or exposure to identity fraud. The vendor certification programs address the procedures in place to ensure that the transaction itself is secure. But, these systems do nothing to ensure that the customer's personal information is not compromised after the sale. These systems do nothing to limit the consumer's exposure to the selling of personal information by merchants and card issuers.

For example, American Express has developed a system that will issue the cardholder a temporary charge account number valid for up to thirty days. When a cardholder uses this unique card number, the actual credit card record is charged the amount of the purchase. The merchant is given a temporary number and not the actual credit card number. Therefore, if after thirty days the merchant's systems were hacked, the customer's personal information such as home address, phone number, items purchased, etc would still be compromised. However, the hackers would not have a valid credit card number. The American Express system and merchant validation systems do not address a fundamental element in any calculation assessing the risk of personal information theft, i.e. for each location that personal information is stored, the risk of possible theft of this information increases linearly.

The current state of the industry is constrained in its ability to limit the risk of identity fraud or the misuse and or theft of personal information. The systems today, secure the transaction through encryption technologies such as Secure Sockets Layer (SSL), Digital Certificates, and Public Key Encryption technologies. The systems today address the hackers through technologies such as Firewalls and Intrusion Detection systems. The merchant certification programs are designed to ensure the merchant has adequate systems to reasonably assure the consumer their transaction will be secure. These systems also ensure that the vendor will not incur a charge back by attempting to verify the consumer through secondary validation systems such as password protection and eventually, Smart Card technology. However, these systems do nothing to limit the number of locations the consumer's personal information is stored. In fact, some of these systems increase the amount of personal information that is stored and increase the number of systems handling and storing this information. As a result, the consumer's risk of Identity Fraud and or misuse of their personal information increases each time the consumer makes a purchase over the Internet.

The current state of the Internet commerce industry has no way of emulating a traditional in store purchase made with cash. The current state of technology does not provide a system whereby a consumer can make an on-line purchase anonymously. Each time a consumer makes a purchase on the Internet, the consumer must provide personal information and provide some form of payment other than cash. Systems have been developed to address the use of credit cards and the problems associated with them. Systems such a Pay Pal allow the consumer to create an account that is tied to a consumer's credit card or bank account. The consumer authorizes a set amount to be debited from their card or account and is available for the consumer to utilize with any merchant that will accept Pay Pal's merchant services. This system and systems like it still do not address the underlying problem of the consumer's personal information is still required at each vendor the consumer wishes to make a purchase from. These systems limit the cost of the transaction and limit the consumer's exposure to a fixed dollar amount but do nothing to limit the consumer's exposure to personal information theft or misuse. Further none of these systems allow for an anonymous transaction to occur through the Internet such as buying in a store and paying with cash.

### SUMMARY OF THE INVENTION

It is an object of this invention to overcome the disadvantages of the prior art by providing a method of conducting transactions over the Internet in an anonymous

It is a feature of this invention that the method of conducting transactions over the Internet utilizes several technologies already in existence to allow a consumer to browse, research, shop and make purchases through an open network such as the Internet and anonymously.

It is a feature of this invention that Internet financial transactions at the consumer level can be conducted securely.

It is an advantage of this invention that the consumer can conduct business over the Internet without fear of being subjected to identity fraud.

It is another advantage of this invention that the method provides the only process available to make an anonymous purchase from any merchant on the Internet.

It is still another advantage of this invention that the Secure Anonymous Transaction Engine does not require merchants to sign up for any special service.

It is still another feature of this invention that consumers would be able to purchase anonymously and securely from any valid merchant operating on the Internet.

It is another object of this invention to limit a consumer's risk of identity fraud by limiting the number of locations that a consumer's personal information is stored.

It is still another advantage of this invention that the actual identity of the consumer operating over the Internet will only be known to the Secure Anonymous Transaction Engine.

Each time a purchase is made through the Secure Anonymous Transaction Engine process, the purchaser's personal information is not propagated to the merchant. The merchant only knows that the Secure Anonymous Transaction Engine process has made a purchase. Therefore, the merchant does not have the consumer's personal information that could be utilized to target market the consumer or profit from the dissemination of personal information in the form of mailing lists, spam e-mail etc. If the merchant site is hacked, the hackers would not gain any personal information from a Secure Anonymous Transaction Engine user that has made a purchase from the hacked merchant. Therefore, the Secure Anonymous Transaction Engine process further limits the risk of identity fraud by limiting the useful information hackers may obtain and or disseminate.

The Secure Anonymous Transaction Engine process virtually guarantees the purchaser's identity through a several step process that combines biometric input, Smart Card technology, user login and password verification and remote authentication. By combining these technologies along with a secure networking environment, the risk of fraudulent purchases made by unauthorized users is significantly reduced. This will have a net effect of reducing charge backs to vendors and lost profits for the card issuers.

The Secure Anonymous Transaction Engine process uses its own unique set of authorized credit cards to make purchases for the consumer, via proxy. This methodology ensures the purchaser's credit card information is only known to the Secure Anonymous Transaction Engine process. Therefore the Secure Anonymous Transaction Engine eliminates the consumer's risk of credit card fraud, and personal identity fraud beyond the single storage point inside the Secure Anonymous Transaction Engine.

The Secure Anonymous Transaction Engine process limits its own risk of fraud by utilizing a unique credit card number for a predefined number of purchases by the Secure Anonymous Transaction Engine process. For example, the Secure Anonymous Transaction Engine credit card number that is propagated to the merchant is valid only for twenty four hours of transactions. Each day, the Secure Anonymous Transaction Engine process disables the previous day's card number and validates the current day's card number. Therefore, the merchant has a credit card that is valid no longer than a twenty four hour period. The card would actually still be valid but would have its limit set to the amount of the purchases for the period that the Secure Anonymous Transaction Engine process had it active. Once the day's transactions have been completely closed out, the credit card number is marked invalid.

The Secure Anonymous Transaction Engine process does not require the merchant to know any of the Secure Anonymous Transaction Engine user's personal information. Therefore, the Secure Anonymous Transaction Engine process provides an anonymous Internet purchasing process that is directly analogous to walking in a store and purchasing merchandise with cash.

These and other objects, features and advantages are accomplished according to the instant invention by providing a method of conducting anonymous transactions over the Internet that protects consumers from identity fraud. The process involves the formation of a Secure Anonymous Transaction Engine to enable any consumer operating over an open network, such as the Internet to browse, collect information, research, shop, and purchase anonymously. The Secure Anonymous Transaction Engine components provide a highly secure connection between the consumer and the provider of goods or services over the Internet by emulating an in store anonymous cash transaction although conducted over the Internet. The Secure Anonymous Transaction Engine is accessible to all merchants conducting business over the Internet and does not require subscription to any special service.

### BRIEF DESCRIPTION OF THE DRAWINGS

The advantages of this invention will become apparent upon consideration of the following detailed disclosure of the invention, especially when taken in conjunction with the accompanying drawings wherein:

FIG. 1 is a diagram depicted the hierarchical structure of the components of the Secure Anonymous Transaction Engine incorporating the principles of the instant invention;

FIGS. 2A through 2C are a logic flow diagram depicting the operation of the Secure Anonymous Transaction Engine process, FIG. 2A and a portion of FIG. 2B depicting the client components and the logical interaction therebetween, the remainder of FIG. 2B and FIG. 2C depicting the client server components and the back office supportive components and the respective logical connections, FIGS. 2A and 2B connecting at matchline A--A and FIGS. 2B and 2C connecting at matchline B--B; and

FIGS. 3A and 3B is a logic flow diagram depicting a representative purchase transaction through the Secure Anonymous Transaction Engine, depicting the functional flow of information during a user session through the Secure Anonymous Transaction Engine, FIGS. 3A and 3B connecting at matchline A--A.

### DETAILED DESCRIPTION OF THE PREFERRED EMBODIMENT

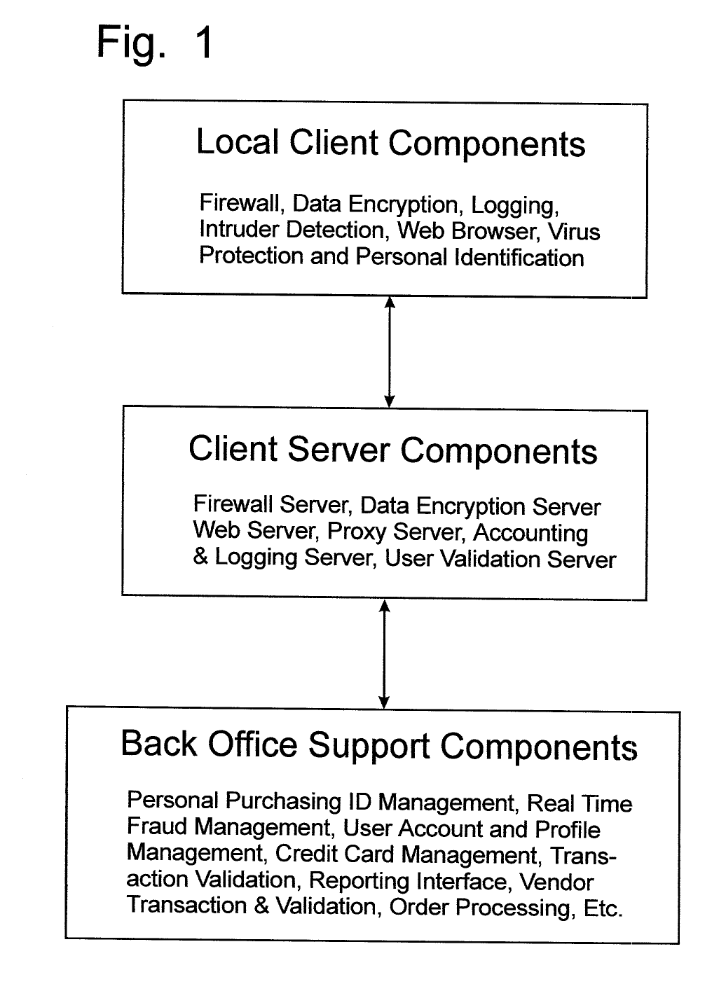

Referring now to FIGS. 1-3B, the details of a process referred to as a Secure Anonymous Transaction Engine incorporating the principles of the instant invention can best be seen. The Secure Anonymous Transaction Engine is a process that is divided into three distinct parts, Local Client Components, Client Server Components, and Back Office Supportive Components. Each component of the process is assigned a part by its functional location in the Secure Anonymous Transaction Engine process. The hierarchical structure of the components of the Secure Anonymous Transaction Engine process is depicted in FIG. 1.

Each part of the Secure Anonymous Transaction Engine process is comprised of hardware and software components that reside at three distinctly separate locations. The Client Components reside at the Secure Anonymous Transaction Engine user's location. A separate copy of these components is uniquely configured for each Secure Anonymous Transaction Engine user. The Client Server Components are designed to be located within a secure environment that contains a high bandwidth connection to the Internet and redundant power and redundant communications resources to provide a highly robust computing environment. The Back Office Supportive Components may be located in the same location as the Client Server Components, or may be located at another location, such as the company headquarters. However, the environmental requirements for the Back Office Supportive components are identical to the Client Server Components with the exception of the high bandwidth Internet connection.

For a tighter security environment, the Back Office Supportive Components do not directly communicate through the Internet. The Back Office Supportive Components communicate via a direct link to the Secure Anonymous Transaction Engine Client Server Components. The Client Server Components communicate with the Secure Anonymous Transaction Engine user, vendors, merchants, and all other content sites the Secure Anonymous Transaction Engine user wishes to communicate with. Therefore, dependent on the scale of the Secure Anonymous Transaction Engine implementation, the scope of redundancy options through a distributed computing architecture increases linearly with the scale of the Secure Anonymous Transaction Engine implementation. In other words, the Secure Anonymous Transaction Engine process is designed in a distributed architecture to allow the Secure Anonymous Transaction Engine process to scale between tens of users and hundreds of millions of users.

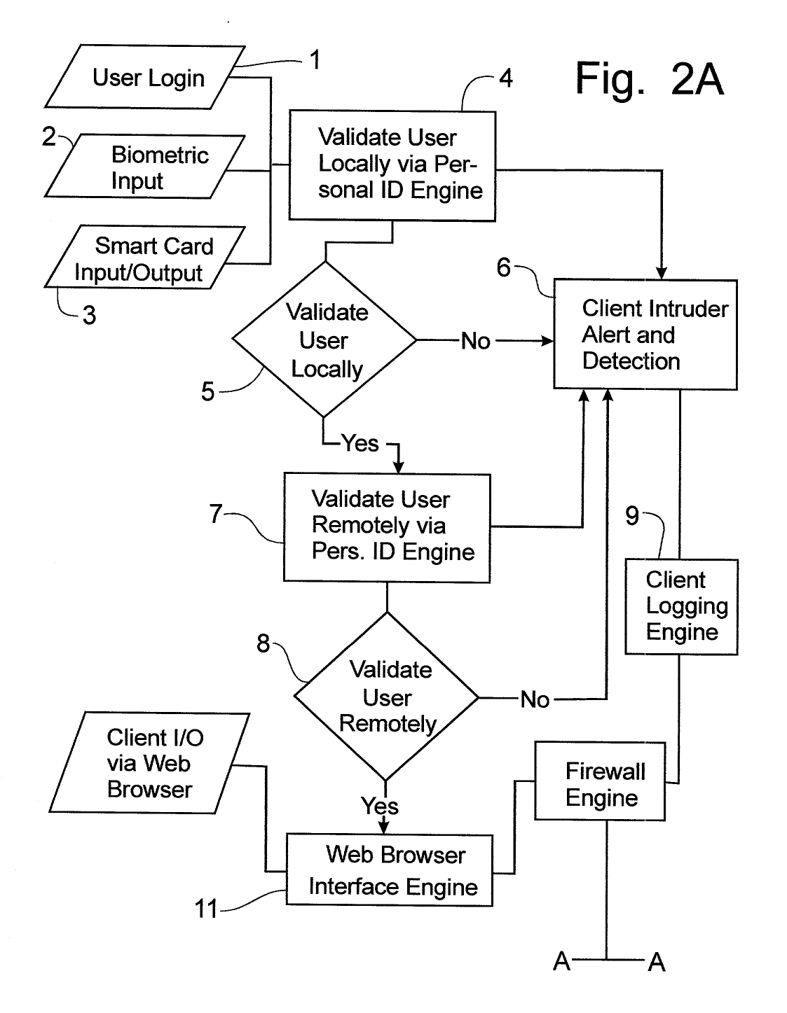

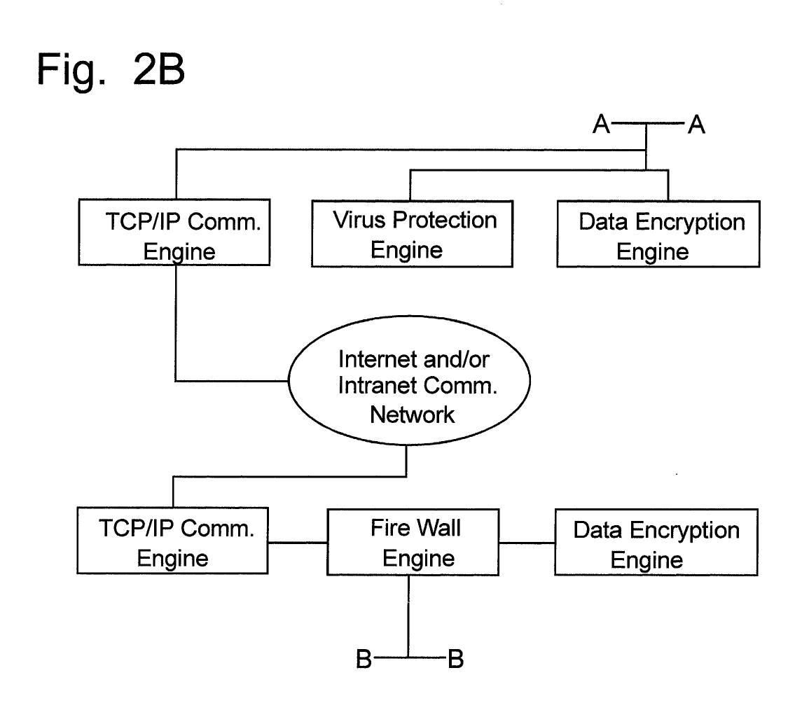

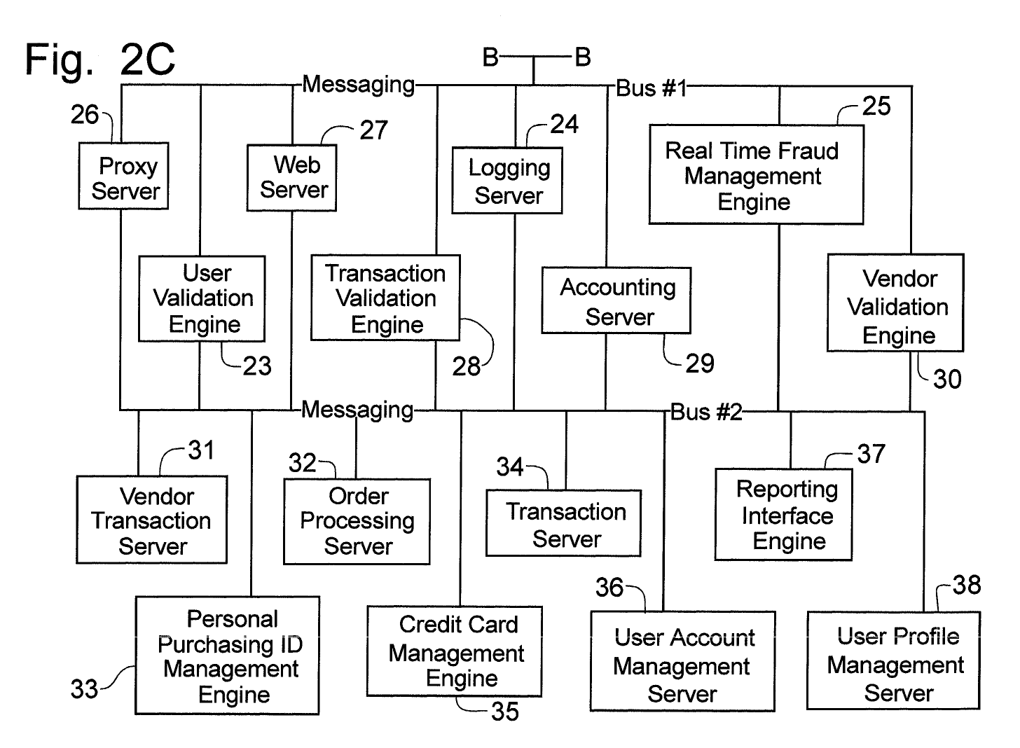

A Block Diagram of the Secure Anonymous Transaction Engine process is depicted in FIGS. 2A-2C. This drawing depicts the major functional components of the Secure Anonymous Transaction Engine. It also depicts the messaging connections between the logical components of the Secure Anonymous Transaction Engine. The drawing is divided into two parts. The first part is depicted in FIG. 2A and a portion of FIG. 2B, forming the Client Components and their logical interaction. The second part is depicted in the remainder of FIG. 2B and FIG. 2C comprising the Client Server Components, and the Back Office Supportive Components and their logical connections.

The Secure Anonymous Transaction Engine is comprised of hardware and software components and a unique order fulfillment process. Most of these components are readily available in the market today. The Secure Anonymous Transaction Engine is a unique process that is created by utilizing these readily available components connected with unique software logic. This unique software logic integrated with “Off the Shelf” components and a unique order fulfillment process makes the Secure Anonymous Transaction Engine process unique and novel.

As a basis for understanding the construction of the Secure Anonymous Transaction Engine, several design prerequisites need to be established. The Secure Anonymous Transaction Engine user's computing environment is assumed to be a standard Personal Computer (PC). In its initial stage of deployment, the Secure Anonymous Transaction Engine process will assume the user's computing environment's operating system is a version of Microsoft Windows. However, the Secure Anonymous Transaction Engine process is designed to be operating system independent and processor independent. A central database structure based on a distributed relational Structured Query Language (SQL) database shall be used for all data storage functions in the Secure Anonymous Transaction Engine. The Secure Anonymous Transaction Engine process utilizes technology that is the current state of the art for the given function within the Secure Anonymous Transaction Engine. The Secure Anonymous Transaction Engine process is designed to be modular so that as the state of the art evolves, for a given Secure Anonymous Transaction Engine component, the old component can be upgraded. This modular design concept will significantly reduce the possibility of the Secure Anonymous Transaction Engine process becoming obsolete because of one of its components has become obsolete. The server components are functionally separated to allow for a multi-threaded asynchronous execution environment.

Dependent upon the scale of the Secure Anonymous Transaction Engine user base supported, the Client Server and the Back Office Components are distributed to multi processor systems that may be clustered to increase throughput and reliability. Each Client Server and the Back Office functional component communicates with other Client Server and the Back Office components of the Secure Anonymous Transaction Engine via a secure messaging bus and the centrally managed database. All Secure Anonymous Transaction Engine components that communicate through the Internet shall utilize IP, IPv6 or Ipsec or the then current standard. All messages traversing the Internet between the Client Components and the Client Server Components will be encrypted using current technologies such as 128 bit Public Key Infrastructure (PKI) encryption implemented through Secure Sockets Layer (SSL) or the then current standard. Each Client Server and the Back Office functional component runs as a separate thread that is independent of the other Client Server and the Back Office components of the Secure Anonymous Transaction Engine. Inter component dependencies are created and managed through messaging and access to the central database.

The security technologies employed by the Secure Anonymous Transaction Engine process shall include the current state of the art in intrusion detection and secure communications technology that include such technologies as Statefull Inspection Firewalls. The Firewall's rules are defined in a security policy that is controlled and updated by the Secure Anonymous Transaction Engine process. Several Firewall technologies exist today. For example Checkpoint's Firewall 1 system as well as several other policy based software technologies. Dependent on the implementation of the Secure Anonymous Transaction Engine, and the level of security desired, hardware and software encryption technologies will be used for all data files and communications that occur through the Internet between Secure Anonymous Transaction Engine components. As detailed above, these encryption techniques shall include PKI and SSL technologies or the then current standard.

In order to provide a complete cohesive secure communications environment for the Secure Anonymous Transaction Engine user, the Secure Anonymous Transaction Engine process incorporates the current technology available for preventing software compromises of the system by utilizing technology known as “Virus Protection” software. However, the name is somewhat misleading as the software has evolved to include protection from other system compromises such as “Trojen Horses”, “Worms” and other active, intrusive system compromises. As with most of the Secure Anonymous Transaction Engine components, Virus Protection is a modular component that can be updated as the current state of the art evolves, thereby limiting the Secure Anonymous Transaction Engine process's obsolescence. This component improves the overall security of the Secure Anonymous Transaction Engine process by limiting the vulnerability of the Secure Anonymous Transaction Engine user's computing environment and consequently the Secure Anonymous Transaction Engine process itself.

Each Secure Anonymous Transaction Engine user must complete an application and installation process that confirms their identity, their location where Secure Anonymous Transaction Engine transactions will be allowed to occur, and a map, or route trace of the Secure Anonymous Transaction Engine user's Internet connection. Although many Internet Service Providers (ISP's) utilize dynamic IP address allocation, and the Internet is designed to provide an indeterminate number of possible paths between any two endpoints, a portion of the route is static. The static portion of the path is used to significantly reduce the number of potential IP address ranges that the Secure Anonymous Transaction Engine user could originate from. The purpose of the network path map is to significantly increase the level of security of the Secure Anonymous Transaction Engine process. By utilizing address masking functions and the ICMP protocol, a path snapshot is recorded in the Intruder Alert and Detection Engine's (6) encrypted data files and in the central database. This snapshot is updated by software when the path intrinsically changes, such as, for example, if the Secure Anonymous Transaction Engine user changes ISP's.

Each time the Secure Anonymous Transaction Engine user logs into the Secure Anonymous Transaction Engine, the current path snapshot is compared with the stored snapshot by both the Personal Identification Engine (4) and the User Validation Engine (23). If the current path snapshot is different from the Secure Anonymous Transaction Engine user's locally stored copy, the Client Intruder Alert and Detection Engine (6) alerts the User Validation Engine (23) and the Real Time Fraud Management Engine (25). If the snapshot path is different from the remotely stored database copy, the User Validation Engine (23) alerts the Client Intruder Alert and Detection Engine (6) and the Real Time Fraud Management Engine (25). The Secure Anonymous Transaction Engine user is disabled in all Secure Anonymous Transaction Engine components until the reason for the discrepancy is resolved by an administrator of the Secure Anonymous Transaction Engine users.

The Secure Anonymous Transaction Engine process starts at the Secure Anonymous Transaction Engine user location. Block (1) User Login represents a software function of the Personal Identification Engine (4). The user is provided a secure login and password that is initially transmitted to the Secure Anonymous Transaction Engine user as part of the installation process of the Secure Anonymous Transaction Engine Client Components. The login and password is initially compared with an encrypted copy, stored locally on the Secure Anonymous Transaction Engine user's PC, Block (5). If, after three attempts, the Secure Anonymous Transaction Engine user fails to enter a correct login and password, the Client Intruder Alert and Detection Engine (6) reports the failed attempt to the User Validation Engine (23), and the Secure Anonymous Transaction Engine user is disabled in all Secure Anonymous Transaction Engine components until an Administrator determines the reason for the failure.

Once the Secure Anonymous Transaction Engine user is validated locally (6), the login and password is sent to the User Validation Engine (23). The User Validation Engine compares the login and password with the copy stored in the central database (7). If the compare fails, (8) the Client Intruder Alert and Detection Engine (6) sends a message to the User Validation Engine (23) and the Real Time Fraud Management Engine (25) and the user is immediately disabled in all Secure Anonymous Transaction Engine components. This type of failed validation (8) represents a possible intruder as the user was validated locally but not validated remotely. Either a system error has occurred or the Secure Anonymous Transaction Engine user's system has been compromised. The Secure Anonymous Transaction Engine user is disabled in all Secure Anonymous Transaction Engine components until an Administrator determines the reason for the failure.

The same process, as detailed above, utilized to validate a Secure Anonymous Transaction Engine user's login and password is utilized to validate the user's Biometric Input (2) and the Secure Anonymous Transaction Engine user's Smart Card (3). The use of these two technologies is dependent on the implementation of the security level of the Secure Anonymous Transaction Engine user. By the addition of Biometric Input and or the use of Smart Card technology, the security level of the Secure Anonymous Transaction Engine user is enhanced. For example, the Secure Anonymous Transaction Engine process may offer three or more levels of security to the user. The first, least secure level, employs only a user login and password, the second level incorporates Biometric Input and the third, highest level, incorporates all three inputs (1), (2) and (3). Other combinations of the three types of user validation may be developed as the market demands.

Once the Secure Anonymous Transaction Engine user is validated locally and remotely, the Client Intruder Alert and Detection Engine (6) and the User Validation Engine (23) enables the Web Browser Interface (11), the Proxy Server (26) and the Web Server (27). The User Validation Engine (23) sends a request to the Personal Purchasing ID Management Engine (33) which in turn creates a unique Personal Purchasing Identification (PPID) that is sent to the Proxy Server (26), the Web Server (27) and the Web Browser Interface Engine (11).

The User Validation Engine's (23) main function is to act as the Secure Anonymous Transaction Engine user's session administrator. It is responsible for requesting the creation of a Secure Anonymous Transaction Engine user session and is responsible for terminating a session under normal conditions. If an error occurs or potential systems' breach occurs, the respective Secure Anonymous Transaction Engine component reports to the User Validation Engine (23) that the session should terminate and the User Validation Engine (23) requests the Personal Purchasing ID Management Engine (33) invalidate the PPID for the given Secure Anonymous Transaction Engine user session. Once the session's PPID is invalidated by the Personal Purchasing ID Management Engine (33), the respective Secure Anonymous Transaction Engine components update their database records and close all Secure Anonymous Transaction Engine process functions associated with the given Secure Anonymous Transaction Engine user's PPID.

The concept of the PPID is a key element in the Secure Anonymous Transaction Engine process. The PPID is utilized throughout the entire Secure Anonymous Transaction Engine process. The PPID is a unique number for each Secure Anonymous Transaction Engine user session. Each time a Secure Anonymous Transaction Engine user begins a Secure Anonymous Transaction Engine session, a new PPID is created. The PPID is used by all Secure Anonymous Transaction Engine components as a mechanism for validating, logging, accounting, and if a purchase is made, shipping and tracking for the Secure Anonymous Transaction Engine user's session activities and purchases.

The PPID is used as the primary key for the Secure Anonymous Transaction Engine user's session database records that are distributed throughout the Secure Anonymous Transaction Engine components' databases. The session database is updated and managed by the individual Secure Anonymous Transaction Engine components involved in a Secure Anonymous Transaction Engine user's session. PPID creation, and validation is performed exclusively by the Personal Purchasing ID Management Engine (33). The Client Intruder Alert and Detection Engine (6) acts as the Secure Anonymous Transaction Engine user's local PPID supervisor. If any of the Client Components detect a session error they report the error to the Client Intruder Alert and Detection Engine, which in turn, reports to the User Validation Engine (23). All of the Secure Anonymous Transaction Engine process Client Server Components and the Back Office Components have the ability to request the PPID Management Engine (33) to invalidate a PPID. Once the PPID is invalidated the entire Secure Anonymous Transaction Engine user session is invalidated and terminated.

The PPID Management Engine (33) serves as the key component that links all of the Secure Anonymous Transaction Engine process's components to the Secure Anonymous Transaction Engine user's session activities, and the user's personal information. It is the component that contains the central database for all session activities. Each time a Secure Anonymous Transaction Engine user begins a session, the PPID Management Engine (33) verifies the Secure Anonymous Transaction Engine user's personal information database, which is stored in the Credit Card Management Engine (35).

The Credit Card Management Engine (35) contains the only database with the Secure Anonymous Transaction Engine user's personal information. This database is accessed by the PPID Management Engine (33), the User Account Management Server (36), and the Real Time Fraud Management Engine (25). The Real Time Fraud Management Engine (25) can only disable a specific Secure Anonymous Transaction Engine user's account. The Real Time Fraud Management Engine (25) only has write access to disable a Secure Anonymous Transaction Engine user's account should an error or potential system's breach occur. The User Account Management Server (36) is the only Secure Anonymous Transaction Engine component that has record creation authority on the Credit Card Management Engine's (35) database. The PPID Management Engine's (33) database access to the Credit Card Management Engine (35) is used to verify the Secure Anonymous Transaction Engine user has a valid, active user account and it in turn updates the Credit Card Management Engine's (35) database with the PPID's that are assigned to the Secure Anonymous Transaction Engine user's sessions.

The PPID Management Engine (33) reports all purchases or debits to the Secure Anonymous Transaction Engine user's actual credit card information contained in the Credit Card Management Engine's (35) personal information database. This design of separating the activities/purchases/session information from the actual user's personal information is a key design constraint of the Secure Anonymous Transaction Engine process. The Secure Anonymous Transaction Engine user's personal information is not replicated in database records throughout the Secure Anonymous Transaction Engine components' databases. All of the Secure Anonymous Transaction Engine components, with the exception of the Credit Card Management Engine (35) contain database records that utilize the PPID to track the Secure Anonymous Transaction Engine user's session activities, and not any of the Secure Anonymous Transaction Engine user's personal information. Therefore, if a systems' breach occurs, each of the Secure Anonymous Transaction Engine components that could potentially be compromised, would only contain information that is coded with the PPID. In other words, a systems breach would have to occur on the Credit Card Management Engine (35) to yield any useful personal information. This critical design constraint is integral in the Secure Anonymous Transaction Engine process's ability to exponentially limit the Secure Anonymous Transaction Engine user's risk to their personal information being compromised each time the Secure Anonymous Transaction Engine user makes a purchase from a merchant/vendor on the Internet.

The Proxy Server (26) and the Web Server (27) operate in conjunction with the PPID to create a secure environment for the Secure Anonymous Transaction Engine user to browse, shop and purchase anonymously throughout the Internet. Once a Secure Anonymous Transaction Engine user has been validated and a PPID or Secure Anonymous Transaction Engine user session has been created, the Secure Anonymous Transaction Engine user is constantly supervised by the User Validation Engine (23) while the Secure Anonymous Transaction Engine user communicates with Internet content providers through secure encrypted communications with the Proxy Server (26) and the Web Server (27).

The proxy/web servers (26/27) make Internet requests via a sockets layer proxy connection to the Secure Anonymous Transaction Engine user's Web Browser Interface Engine (11) or by the then current standard for web/proxy interfaces. Therefore, the Secure Anonymous Transaction Engine user can, via proxy, browse and shop on the Internet through a secure web/proxy interface. By utilizing this design in conjunction with the PPID, a Secure Anonymous Transaction Engine user communicates with Internet content providers by communicating only with the Secure Anonymous Transaction Engine process's components. All Internet communications requested by the Secure Anonymous Transaction Engine user is performed via proxy, thereby anonymously with respect to the Secure Anonymous Transaction Engine user and the Internet content provider, since the Internet content provider only interacts with the Secure Anonymous Transaction Engine Proxy Server (26) and the Secure Anonymous Transaction Engine Web Server (27). This design concept provides a critical element in the Secure Anonymous Transaction Engine process's ability to emulate an anonymous cash transaction through the Internet.

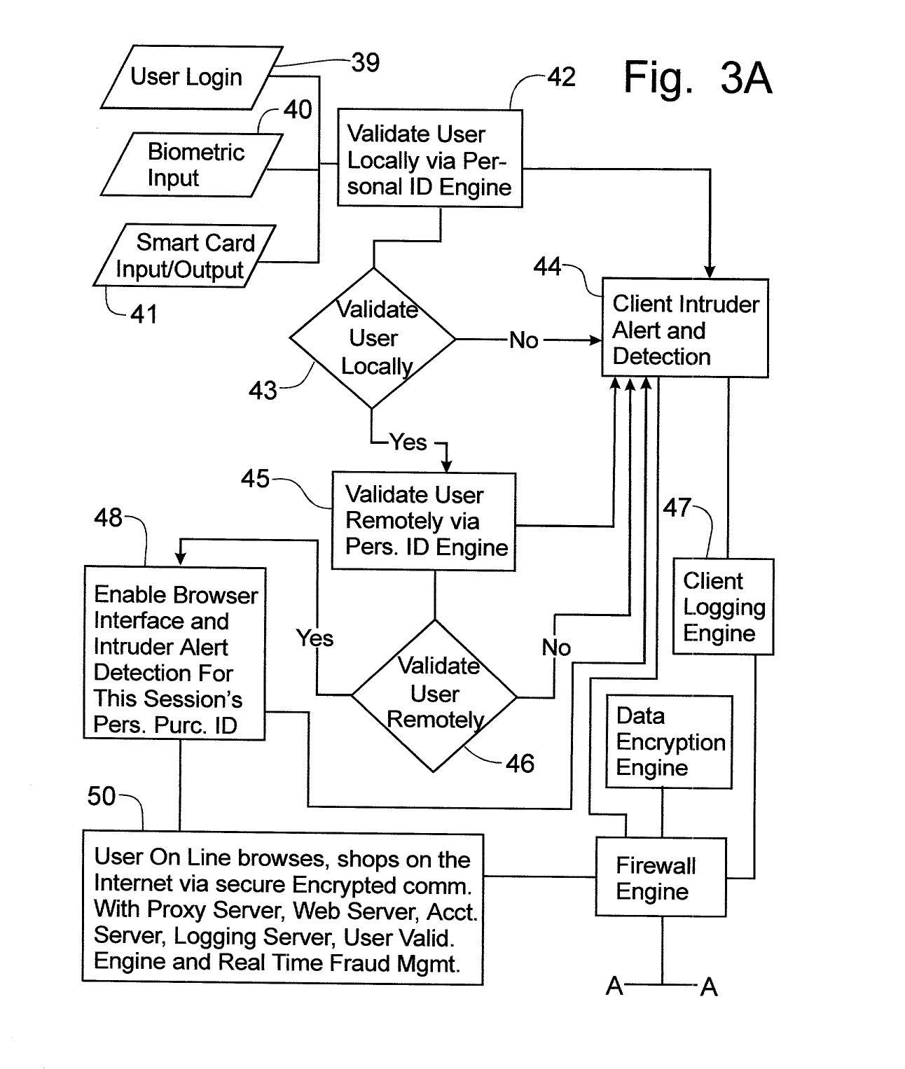

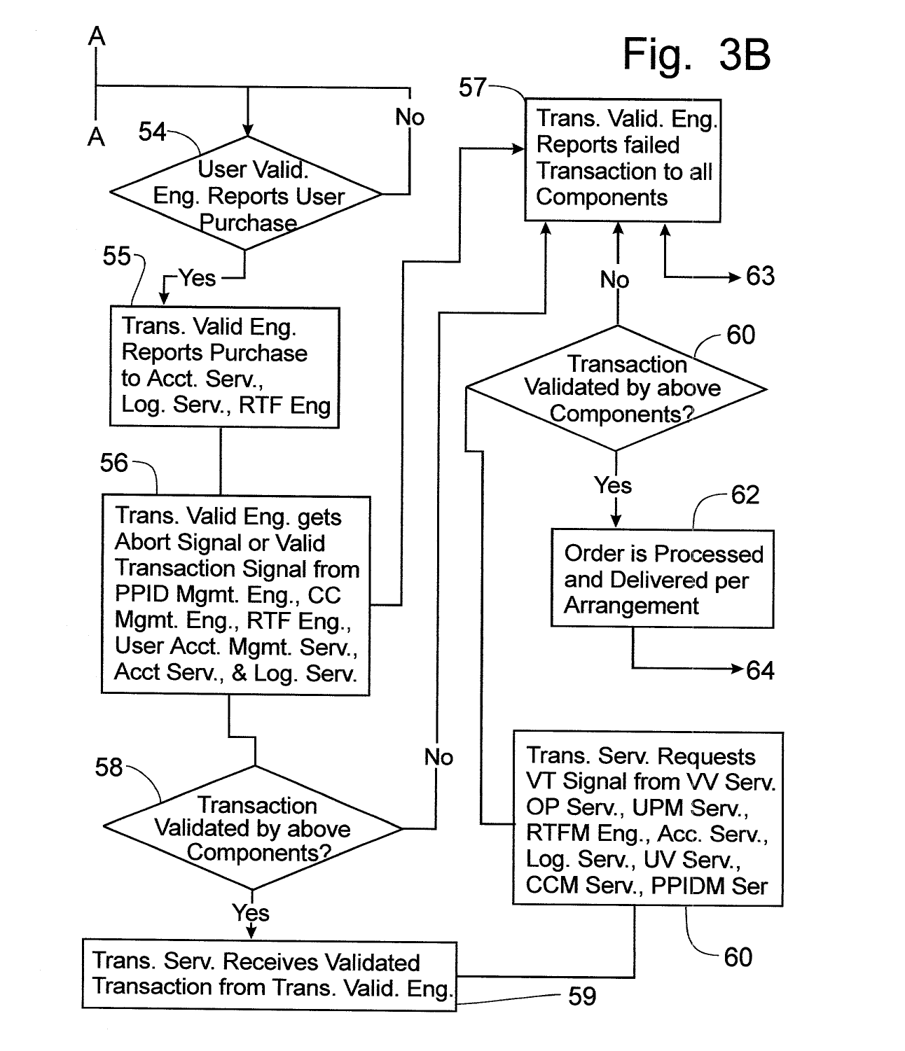

A Secure Anonymous Transaction Engine session that includes a Secure Anonymous Transaction Engine user's purchase is detailed FIGS. 3A and 3B. The Secure Anonymous Transaction Engine user login and validation function occurs as detailed above. The functions described above, incorporate functional blocks (39, 40, 41, 42, 43, 44, 45, 46) Once the user is logged on to the Secure Anonymous Transaction Engine process and a PPID is created, the Client Browser Interface Engine (48) is enabled by a PPID as detailed above. The Client Intruder Alert and Detection Engine (44) monitors the Secure Anonymous Transaction Engine Client Components and communicates the Client Components' status to the Secure Anonymous Transaction Engine process by controlling the local status of the current PPID. This local PPID status is monitored and supervised by the User Validation Engine (54).

Functional block (50) represents the Secure Anonymous Transaction Engine user has obtained a validated PPID and is currently browsing, researching, and or shopping anywhere on the Internet via secure communications with the Secure Anonymous Transaction Engine Proxy Server and the Secure Anonymous Transaction Engine Web Server, as detailed above. All Client Component communications is logged by the Client Logging Engine (47). All logging functions are database keyed to the session PPID. Therefore, if, for any reason, a complete audit trail is required, the Client Logging Engine will report all of the Secure Anonymous Transaction Engine user's communications activities by each session the Secure Anonymous Transaction Engine user initiates. The Logging Server (24) is also logging all communications and Secure Anonymous Transaction Engine component invocations. Therefore, either the Client Logging Server (9) or the Logging Server (24) have the information required to provide a complete audit trail of the Secure Anonymous Transaction Engine user's communications and activities during the Secure Anonymous Transaction Engine user's session. This design concept of two functional logging servers ensures the Secure Anonymous Transaction Engine process will have a complete record of all session transactions and or activities the Secure Anonymous Transaction Engine user initiates through the Secure Anonymous Transaction Engine process.

If the Secure Anonymous Transaction Engine user decides to make a purchase, depicted by functional block (54), the Secure Anonymous Transaction Engine purchase process is initiated by the User Validation Engine (23). The Proxy Server/Web Server (26,27) is responsible for triggering the User Validation Engine (23) when a Secure Anonymous Transaction Engine user decides to make a purchase. The User Validation Engine (23) is then responsible for triggering the requisite Secure Anonymous Transaction Engine components to complete the purchase. The step is depicted in functional block (54).

Once the Transaction Validation Engine (28) is triggered by the User Validation Engine (23), to make a purchase on behalf of the Secure Anonymous Transaction Engine user, the Transaction Validation Engine (28) reports the purchase to the Accounting Server (27), the Logging Server (24), and the Real Time Fraud Management Engine (25). The Accounting Server (27) logs the purchase request by PPID and requests the PPID Management Engine (33) to confirm it has accepted the PPID purchase request. If the PPID Management Engine fails to report to the Transaction Validation Engine (28) and the Accounting Server (27) that the PPID is validated to make the purchase, the Transaction Validation Engine (28) requests the Real Time Fraud Management Engine (25) invalidate the transaction and the Real Time Fraud Management Engine (25) requests all Secure Anonymous Transaction Engine components invalidate the session's PPID and the purchase transaction is aborted. This process is depicted in functional block (55). The Accounting Server (27) is responsible for recording all Secure Anonymous Transaction Engine purchase transactions. Or, in other words, all Secure Anonymous Transaction Engine processes that include some form of purchase or an exchange of money through the Secure Anonymous Transaction Engine process. Once a purchase request has been triggered as detailed above, the Transaction Validation Engine (28) is responsible for supervising and monitoring the purchase transaction. The Transaction Validation Engine's (28) process of monitoring and supervising the purchase transaction is functionally similar to the way the User Validation Engine (23) supervises and monitors the session through the use of the PPID.

The Transaction Validation Engine (28) waits a predetermined amount of time for the PPID Management Engine (33) to request the Credit Card Management Engine (35) to confirm that the Secure Anonymous Transaction Engine user's credit card account is authorized to make a purchase in the amount requested by the Secure Anonymous Transaction Engine user. It is also waiting a predetermined amount of time for the Real Time Fraud Management Engine (25), and the User Account Management Server (36) to confirm via database messaging that the Secure Anonymous Transaction Engine user is authorized to make the purchase for the amount specified. All messaging is logged by the Logging Server (24) and it is polled by the Transaction Validation Engine (28) to confirm that it is logging all Secure Anonymous Transaction Engine functional component invocations. This Secure Anonymous Transaction Engine purchase process step is depicted in functional block (56).

If an error occurs or one of the above Secure Anonymous Transaction Engine purchase process components does not confirm their invocation to the Transaction Validation Engine (28), and a predetermined amount of time has elapsed, the Transaction Validation Engine (28), reports to all Secure Anonymous Transaction Engine components that the purchase transaction is aborted. This step is depicted in functional block (57) and (58). If the Transaction Validation Engine (28) gets confirmation that the above purchase process is complete this far, then the Transaction Validation Engine (28) begins the actual purchase process. This conditional move to the next steps toward completing the Secure Anonymous Transaction Engine user's purchase is depicted in functional block (58). The Transaction Validation Engine (28) then triggers the Transaction Server (34) to begin the process of the Secure Anonymous Transaction Engine to actually making the purchase on behalf of the Secure Anonymous Transaction Engine user. This step is depicted in functional block (59).

Once the Transaction Server (34) receives a valid transaction signal from the Transaction Validation Engine (28) the Transaction Server (34) triggers the Order Processing Server (32). The Order Processing Server (32) triggers the Vendor Validation Engine (30). The Vendor Validation Engine (30) is responsible for supervising and monitoring the vendor purchase or actual purchase transaction from the Internet Vendor or Merchant. The Vendor Validation Engine (30) is responsible for validating and reporting to the Transaction Validation Engine (28) which is monitoring the entire transaction. The Transaction Validation Engine (28) reports to the User Validation Engine (23) which is monitoring and supervising the Secure Anonymous Transaction Engine user's session which in turn reports to the PPID Management Engine (33) which is monitoring and supervising the PPID. The PPID Management Engine (33) reports to the Credit Card Management Engine (35) which is recording and authorizing the Secure Anonymous Transaction Engine process to debit the Secure Anonymous Transaction Engine user's credit card account for the amount of the purchase. The Credit Card Management Engine (35) also is responsible for controlling, authorizing, and issuing a Secure Anonymous Transaction Engine credit card number that is used to make the actual purchase.

Once the Vendor Validation Engine (28) is triggered, it reports via database messaging to the User Profile Management Server (38). The User Profile Management Server (38) compares the requested Secure Anonymous Transaction Engine user's purchase to the historical purchase database and the Secure Anonymous Transaction Engine user's purchase criteria established when the Secure Anonymous Transaction Engine user's account was established. The User Profile Management Server (38) and the User Account Management Server (36) are the only two Secure Anonymous Transaction Engine components to contain a Secure Anonymous Transaction Engine user's account number. The Secure Anonymous Transaction Engine user's account number is used as a database key for the network map of the Secure Anonymous Transaction Engine user's connection and the Secure Anonymous Transaction Engine user's login validation information such as login, password, biometric input and or Smart Card number. The Secure Anonymous Transaction Engine user's account number is tied to the Secure Anonymous Transaction Engine user's personal information which is only stored in the Credit Card Management Engine's (35) database. Therefore, the Secure Anonymous Transaction Engine user's account number contains no useful information outside of the Credit Card Management Engine's (35) database.

The Vendor Validation Engine (30) requests the Vendor Transaction Server (31) to begin the process of ordering the Secure Anonymous Transaction Engine user's purchase from the Internet Merchant or Vendor. The Order Processing Server (32) is triggered by the Vendor Transaction Server (30). The Order Processing Server (32) is responsible for providing the shipping information, the order number, and all functions associated with tracking an order just as it would in a normal order processing environment.

Any communication that is required to the Internet Merchant or Vendor to complete the purchase is performed by the Vendor Validation Engine (30). If the Secure Anonymous Transaction Engine user's requested purchase is to a Secure Anonymous Transaction Engine process's validated vendor, then the Vendor Validation Engine (30) is triggered by the Vendor Transaction Server (31) that this purchase does not require a new Secure Anonymous Transaction Engine vendor validation ID. If the vendor does not already have a Secure Anonymous Transaction Engine process's validated vendor ID, then the Order Processing Server (32) marks this transaction as placed in a hold queue until the vendor can be externally validated through an external process similar to the Secure Anonymous Transaction Engine user's account establishment process. This step ensures that the Secure Anonymous Transaction Engine process will only process orders automatically from vendors that have been validated by external means prior to the Secure Anonymous Transaction Engine process making any purchases on behalf of the Secure Anonymous Transaction Engine user.

Once a new vendor is validated by the Secure Anonymous Transaction Engine process, orders placed to the vendor can be processed automatically by the Secure Anonymous Transaction Engine process. However, if the Secure Anonymous Transaction Engine process has not validated the vendor then the Secure Anonymous Transaction Engine user's purchase is queued for manual intervention and processing by a Secure Anonymous Transaction Engine vendor administrator. This design concept ensures that all automated purchases are validated externally by a strict vendor validation process before the Secure Anonymous Transaction Engine process will process orders automatically. However, the Secure Anonymous Transaction Engine user is not restricted to just vendors that have been validated by the Secure Anonymous Transaction Engine process, since a vendor validation administrator is responsible for monitoring and processing all orders that are in the hold queue for manual processing. In other words, if a vendor has not been validated by the Secure Anonymous Transaction Engine process, the order just takes a little longer to process since it now requires input from a vendor administrator.

Once a vendor has a Secure Anonymous Transaction Engine process validated vendor ID, the Secure Anonymous Transaction Engine process can process the order automatically. The Vendor Validation Engine (28) requests the PPID Management Engine (33) to provide a Secure Anonymous Transaction Engine process (owned) credit card number to provide a payment vehicle to the vendor/merchant. The Credit Card Management Engine (35) has a series of credit cards that are owned and authorized by the Secure Anonymous Transaction Engine. The Credit Card Management Engine (35) provides the PPID Management Engine (33) an authorization ID that is used to tie the Secure Anonymous Transaction Engine user's PPID to the Secure Anonymous Transaction Engine process's credit card transaction.

The Secure Anonymous Transaction Engine credit cards are validated and used for a predetermined number of transactions and or dollar amount and or predetermined amount of time, and or any practical combination of the above. These credit cards are owned and controlled by the Secure Anonymous Transaction Engine process. This design concept ensures that the Secure Anonymous Transaction Engine process and not the Secure Anonymous Transaction Engine user's credit card information is disseminated to the vendor or merchant. This design concept is a critical function in limiting the Secure Anonymous Transaction Engine user's risk to personal information fraud and or misuse as well as creating an anonymous transaction in that the actual Internet Vendor/Merchant does not have any of the Secure Anonymous Transaction Engine user's personal information when the Secure Anonymous Transaction Engine process makes a purchase for the Secure Anonymous Transaction Engine user.

By limiting the use of the Secure Anonymous Transaction Engine process's credit cards to a limited number of transactions as described above, the Secure Anonymous Transaction Engine process also limits its fraud potential in that a specific credit card is only valid for a short period of time. Also, the Secure Anonymous Transaction Engine process is in control of authorizing credit card purchases for itself. Therefore, the Real Time Fraud Management Engine (25) is responsible for the supervision of all credit card transactions that are authorized. However, the Real Time Fraud Management Engine's (25) database does not contain any valid credit card information. It only contains a list of the credit cards that have been invalidated and or expired and or have reached their purchase limit. Therefore, if a request from a vendor is received for a credit card that is not currently in use, the Real Time Fraud Management Engine (25) will mark the transaction as potential fraud and or an error has occurred since only one Secure Anonymous Transaction Engine process's credit card is ever valid at any given time. Further, the Credit Card Management Engine (35) is the only database that contains valid credit cards.

Once the Vendor Validation Engine (30) receives authorization from the PPID Management Engine (33) to make a Secure Anonymous Transaction Engine user's purchase from a Secure Anonymous Transaction Engine validated vendor/merchant the Order Processing Server (32), the Vendor Transaction Server (31), The User Profile Management Server (38), the Real Time Fraud Management Engine (25), the Accounting Server (29), the Logging Server (24), all perform their respective functions as described above and report their status to the Vendor Validation Engine (30). This step as described above is depicted by functional block (61).

If the above Secure Anonymous Transaction Engine process components all report a validated vendor transaction has occurred, the Vendor Validation Engine (30) reports the purchase transaction status to the Transaction Validation Engine (28). If an error occurred or the transaction was aborted due to potential fraud, the Transaction Validation Engine (30) reports the failed transaction to the Real Time Fraud Management Engine (25) which in turn reports to the User Validation Engine (23) and the PPID Management Engine (33) that the transaction has failed and to mark the transaction for review by the Reporting Interface Engine (37) and a transaction administrator. The PPID is marked invalid and the Secure Anonymous Transaction Engine user's session is terminated. This functional step is depicted by functional blocks (60, 61).

If the Secure Anonymous Transaction Engine user's purchase has been validated by all Secure Anonymous Transaction Engine components, the order is completed and is delivered by the Secure Anonymous Transaction Engine order fulfillment process described below as depicted in functional block (62). The Secure Anonymous Transaction Engine user is notified that the Secure Anonymous Transaction Engine user's purchase has been released to the Secure Anonymous Transaction Engine order fulfillment process and the Secure Anonymous Transaction Engine Web Browser Interface Engine (11) is enabled to continue to process the Secure Anonymous Transaction Engine user's requests as described above. This functional step is depicted by connecting arrow (64). If an error occurs during the purchase transaction, the PPID is invalidated and this information is sent to the Secure Anonymous Transaction Engine Client Intruder Alert and Detection Engine (44). This step is depicted by connecting arrow (63).

Once a Secure Anonymous Transaction Engine user's purchase has been processed as described above, the Secure Anonymous Transaction Engine must now fulfill the Secure Anonymous Transaction Engine user's order/purchase. If the purchase requires shipment, and delivery to the Secure Anonymous Transaction Engine user the order is fulfilled by the Secure Anonymous Transaction Engine process's unique order fulfillment process. The Secure Anonymous Transaction Engine process's order fulfillment process is designed to work in at least two distinct ways. In the first method the Secure Anonymous Transaction Engine process has an order fulfillment center that receives all shipments from the Internet Vendors/Merchants. This order fulfillment center processes orders it receives from the vendors verifies the order is not visibly damaged and then places a shipment label over the original shipment label and then sends the shipment on to the Secure Anonymous Transaction Engine user's requested delivery address.

The original shipment from the vendor/merchant has the user's PPID as the method for identifying the Secure Anonymous Transaction Engine user the shipment is ultimately destined for. The order fulfillment center receives all shipments from the vendors/merchants and when a Secure Anonymous Transaction Engine user's shipment arrives from the vendor/merchant the PPID is searched, the Credit Card Management Server performs a database search and outputs a shipping label with the Secure Anonymous Transaction Engine user's requested ship to address. This design concept for order fulfillment is the final Secure Anonymous Transaction Engine process component that is required to emulate a full anonymous cash transaction over the Internet. The vendor/merchant only knows the Secure Anonymous Transaction Engine process's order fulfillment address and not the Secure Anonymous Transaction Engine user's address. Therefore, as far as the Secure Anonymous Transaction Engine user and the vendor/merchant are concerned, only the Secure Anonymous Transaction Engine user and the Secure Anonymous Transaction Engine process has any of the Secure Anonymous Transaction Engine user's personal information.

A second method involves a Secure Anonymous Transaction Engine process authorized shipping agent. This method also utilizes the PPID that is associated with a Secure Anonymous Transaction Engine user's shipping address. The Secure Anonymous Transaction Engine process's authorized shipping agent picks up the package from the vendor/merchant. Then the Secure Anonymous Transaction Engine shipping agent requests the Secure Anonymous Transaction Engine process to correlate the Secure Anonymous Transaction Engine user's PPID to the actual shipping address of the Secure Anonymous Transaction Engine user. This method is not quite as anonymous as the first method in that the Secure Anonymous Transaction Engine process's shipping agent's database contains the Secure Anonymous Transaction Engine user's actual shipping address thereby releasing some Secure Anonymous Transaction Engine user's information to a Secure Anonymous Transaction Engine process's authorized shipping agent. However, this method does release some Secure Anonymous Transaction Engine user information none the less.

Accordingly, method one is the preferred design for order fulfillment in that no Secure Anonymous Transaction Engine user information ever leaves the Secure Anonymous Transaction Engine process. However, the second method could be modified to include a pick up point at the Secure Anonymous Transaction Engine process's shipping agent's pick up locations and is then picked up by the Secure Anonymous Transaction Engine user. The Secure Anonymous Transaction Engine user merely presents a Smart Card or an authorizing slip generated by the Secure Anonymous Transaction Engine process that confirms the PPID is to be picked up by the Secure Anonymous Transaction Engine user. This design concept for the order fulfillment process completes the design of a fully emulated anonymous cash transaction that exponentially limits the Secure Anonymous Transaction Engine user's risk of personal information fraud and or misuse.

The Reporting Engine (37) is used to as a report generator for all Secure Anonymous Transaction Engine process activities. It is responsible for collecting and collating information based on the Secure Anonymous Transaction Engine process's component invocations and all Secure Anonymous Transaction Engine user activities. It is responsible for querying the individual component databases and provides a method for intelligently reporting and monitoring the Secure Anonymous Transaction Engine process through clear concise reports.

It will be understood that changes in the details, materials, steps and arrangements of components which have been described and illustrated to explain the nature of the invention will occur to and may be made by those skilled in the art upon a reading of this disclosure within the principles and scope of the invention. The foregoing description illustrates the preferred embodiments of the invention; however, concepts, as based upon the description, may be employed in other embodiments without departing from the scope of the invention.

Having thus described the invention, what is claimed is:

1. A method of conducting a transaction over an open network for a client comprising the steps of:
accessing a client identification process by the client to provide validation of the client to initiate a transaction session;
assigning a personal purchasing identification number to the client corresponding to the transaction session;
establishing connection through the open network for the client using the personal purchasing identification number through a proxy to permit the client to access transaction vendors anonymously;
entering into a transaction with a transaction vendor via the personal purchasing identification number;
effecting payment for the transaction from the client to the proxy; and
confirming payment to the vendor from the proxy for the transaction.

2. The method of claim 1 wherein said step of effecting payment for the transaction utilizes a credit card having corresponding credit card information issued to the proxy for a limited period of time so that the exposure of the credit card information over the open network is limited in time.

3. The method of claim 2 wherein said limited period of time during which the credit card can be used for purchases over the open network is one day.

4. The method of claim 2 wherein said personal purchasing identification number is utilized over the open network only for a limited period.

5. The method of claim 4 wherein said limited period is a period of time for validity of said personal purchasing identification number, said period of time being one day.

6. The method of claim 4 wherein said limited period corresponds to a predetermined number of uses of said personal purchasing identification number.

7. The method of claim 6 wherein said predetermined number of uses for which said personal purchasing identification number is valid is one transaction.

8. The method of claim 4 wherein said step of accessing a client identification process involves at least one of password protection, biometric input protection and smart cart input/output protection.

9. The method of claim 4 wherein said proxy is a server connected to other servers to validate client information and identification, maintain account information, validate and track transactions, and validate vendors of transactions.

10. The method of claim 9 wherein one of said other servers is a credit card management server on which is stored said credit card information, said credit card management server is protected by at least one firewall engine and access from outside said process through a client intruder alert and detection engine.

11. The method of claim 9 wherein communications between said client and said proxy server is encrypted.

12. The method of claim 1 wherein said transaction involves the purchase of goods, said method further comprising the steps of:
shipping of said goods by said vendor to a courier for delivery of said goods to said client;
informing said courier of a delivery address corresponding to said personal purchasing identification number by said proxy; and
delivering said goods to said client by said courier.

13. A method of providing an anonymous transaction for a client over the Internet comprising the steps of:
interposing a secure anonymous transaction engine between said client and said Internet for said client to access the Internet;
validating the identity of said client;
assigning a personal purchasing identification number to said client;
using a proxy server to permit said client to browse the Internet through the identity of said personal purchasing identification number;
maintaining client information, including identity information and credit card information on a credit card management server within said secure anonymous transaction engine;
entering into a transaction with a transaction vendor by said proxy server using said personal purchasing identification number;
effecting payment for the transaction from the client to the secure anonymous transaction engine; and
confirming payment to the vendor from the secure anonymous transaction engine for the transaction.

14. The method of claim 13 wherein said step of validating the identity of said client utilizes at least one of password protection, biometric input protection and smart cart input/output protection.

15. The method of claim 13 wherein said step of effecting payment for the transaction utilizes a credit card having corresponding credit card information issued to the secure anonymous transaction engine for a limited period of time so that the exposure of the credit card information over the open network is limited in time.

16. The method of claim 15 wherein the use of said personal purchasing identification number is limited by at least one of time or number of uses.

17. The method of claim 16 wherein the valid use of said personal purchasing identification number is limited to a time period of approximately one day.

18. The method of claim 16 wherein said credit card management server is protected from access from outside the secure anonymous transaction engine by at least one firewall engine and through a client intruder alert and detection engine.

19. A secure anonymous transaction system for permitting a client to communicate with a vendor over the Internet without exposing the client's identity or the client's financial information comprising:
a proxy server through which said client can communicate over the Internet without divulging the identity of the client;
a virus protection engine to detect and prevent the entry of viruses and similar devices into said secure anonymous transaction system;
a firewall to limit access into the secure anonymous transaction system; and
data encryption for encrypting communications between the client and the proxy server.

20. The secure anonymous transaction system of claim 19 further comprising:
a client validity engine to validate the identity of the client before permitting access of said client into said secure anonymous transaction system;
a personal purchasing identification management engine to assign a personal purchasing identification number to said client upon being validated to permit communication over the Internet by said proxy server without divulging the identity of said client; and
an audit trail engine to track transactions for said client within said secure anonymous transaction system without providing client information outside the secure anonymous transaction system.

21. The secure anonymous transaction system of claim 20 wherein the personal purchasing identification number assigned by said personal purchasing identification management engine has a limited duration for validity.

22. The secure anonymous transaction system of claim 20 wherein said audit trail engine provides user trend information for utilization within said secure anonymous transaction system.

23. The secure anonymous transaction system of claim 20 further comprising:
a credit card management server on which is stored credit card information of said client, said credit card management server providing a proxy credit card number to said vendor upon the entry of a commercial transaction on behalf of said client.

24. The secure anonymous transaction system of claim 23 wherein said proxy credit card number has a limited validity period.

25. A secure anonymous transaction system for permitting a client to communicate with a vendor over the Internet without exposing the client's identity or the client's financial information comprising:
a proxy server through which said client can communicate over the Internet without divulging the identity of the client;
a client validity engine to validate the identity of the client before permitting access of said client into said secure anonymous transaction system;
a personal purchasing identification management engine to assign a personal purchasing identification number to said client upon being validated to permit communication over the Internet by said proxy server without divulging the identity of said client; and
a credit card management engine on which is stored credit card information of said client, said credit card management engine providing a proxy credit card number to said vendor upon the entry of a commercial transaction on behalf of said client.

26. The secure anonymous transaction system of claim 25 further comprising:
a virus protection engine to detect and prevent the entry of viruses and similar devices into said secure anonymous transaction system; and
a firewall to limit access into the secure anonymous transaction system.

27. The secure anonymous transaction system of claim 26 further comprising:
an audit trail engine to track transactions for said client within said secure anonymous transaction system without providing client information outside the secure anonymous transaction system.

28. The secure anonymous transaction system of claim 26 wherein communications between said client and said secure anonymous transaction system are encrypted by data encryption software.

29. The secure anonymous transaction system of claim 25 wherein the personal purchasing identification number assigned by said personal purchasing identification management engine has a limited duration for validity, said proxy credit card number also having a limited validity period.

30. The secure anonymous transaction system of claim 25 further comprising:
a shipping center for receiving goods from said vendor shipped to said personal purchasing identification number, said shipping center being operable to direct said goods to said client so that said client remains anonymous to said vendor.
